(19) United States
(12) Patent Application Publication
(10) Pub. No.: US 2026/0129343 A1
(43) Pub. Date: May 7, 2026

(54) ELECTRONIC DEVICES AND EARPHONES

(71) Applicant: SHENZHEN SHOKZ CO., LTD., Shenzhen (CN)

(72) Inventors: Yongjian LI, Shenzhen (CN); Zhao XIE, Shenzhen (CN); Xiaobang WEN, Shenzhen (CN)

(73) Assignee: SHENZHEN SHOKZ CO., LTD., Shenzhen (CN)

(21) Appl. No.: 19/433,923

(22) Filed: Dec. 28, 2025

Related U.S. Application Data
(63) Continuation of application No. PCT/CN2024/086440, filed on Apr. 7, 2024.

(51) Int. Cl. H04R 1/10; H04R 1/1025

(52) U.S. Cl. CPC H04R 1/1058; H04R 1/1008; H04R 1/1025; H04R 2420/09

(57) ABSTRACT

The present disclosure relates to an electronic device and an earphone. The electronic device includes: a device main body provided with a connection port; an interface plug including a plug main body and a connecting member; and a locking member. The plug main body is configured to be inserted into the connection port, and the connecting member is connected between the plug main body and the device main body. A locking member insertion cavity is provided on the device main body, the locking member is inserted into the locking member insertion cavity, an insertion direction of the locking member when being inserted into the locking member insertion cavity and a pull-out direction of the interface plug when being pulled out from the connection port form an included angle, a limiting structure is provided on the connecting member, and the locking member blocks the limiting structure along the pull-out direction.

### CROSS-REFERENCE TO RELATED APPLICATIONS

This application is a continuation of International Patent Application No. PCT/CN2024/086440, filed on April 07, 2024, the contents of which are hereby incorporated by reference.

### TECHNICAL FIELD

The present disclosure generally relates to the field of electronic devices, and in particular, to an electronic device and an earphone.

### BACKGROUND

A device main body of an electronic device is often provided with a connection port. The electronic device is able to connect to an external device through the connection port. For example, an earphone is often provided with a charging interface. The charging interface can be used to connect to a charger. After the external device is disconnected from the connection port, an interface plug may be installed in the connection port to block the connection port. The interface plug provides a protective function for the connection port.

When designing the interface plug, the connection between the interface plug and the device main body of the electronic device needs to be considered.

### SUMMARY

An embodiment of the present disclosure provides an electronic device. The electronic device includes: a device main body provided with a connection port; an interface plug including a plug main body and a connecting member; and a locking member. The plug main body is configured to be inserted into the connection port, and the connecting member is connected between the plug main body and the device main body. A locking member insertion cavity is provided on the device main body, and the locking member is inserted into the locking member insertion cavity. An insertion direction of the locking member when being inserted into the locking member insertion cavity and a pull-out direction of the interface plug when being pulled out from the connection port form an included angle. A limiting structure is provided on the connecting member, and the locking member blocks the limiting structure along the pull-out direction.

In an embodiment, the insertion direction is perpendicular to the pull-out direction.

In an embodiment, the device main body has a connection side surface for the connecting member to connect thereto, a mounting groove extending along the pull-out direction is provided on the connection side surface, and at least a portion of the connecting member along a groove depth direction of the mounting groove is embedded in the mounting groove.

In an embodiment, the connecting member includes a columnar body and a limiting protrusion, the limiting protrusion protrudes from a side surface of the columnar body, and the limiting structure is formed by the limiting protrusion.

The locking member includes a stop component and an insertion component. The stop component blocks the limiting protrusion from moving toward the columnar body, the insertion component is connected to the stop component, and the insertion component and the stop component form an included angle. The locking member insertion cavity is an insertion recess provided on the connection side surface, and the insertion component is inserted into the insertion recess.

In an embodiment, there are two insertion components, and the two insertion components are respectively provided at opposite ends of the stop component. There are two insertion recesses corresponding to the two insertion components, and the two insertion recesses are respectively located on two sides of the mounting groove in a groove width direction.

In an embodiment, the locking member is sheet-shaped.

In an embodiment, the locking member includes an ear component; the ear component is connected to a side of the stop component away from the limiting protrusion; and the ear component covers at least a portion of the columnar body.

In an embodiment, the columnar body has an inner side surface facing a groove bottom wall of the mounting groove, an inner protrusion is provided on the inner side surface, an embedding slot is provided on the groove bottom wall of the mounting groove, and the inner protrusion is embedded in the embedding slot.

In an embodiment, the connecting member is completely embedded in the mounting groove, and a side surface of the connecting member away from a groove bottom wall of the mounting groove is flush with an opening edge of the mounting groove.

In an embodiment, the connecting member is provided with an insertion hole, the limiting structure is formed by the insertion hole, the locking member is a locking pin, and the locking pin is simultaneously inserted into the locking member insertion cavity and the insertion hole.

In an embodiment, an insertion channel is provided on the device main body, an axis of the insertion channel is parallel to the pull-out direction, the connecting member is inserted into the insertion channel, two locking pin holes are provided on two opposite side walls of the insertion channel, the two locking pin holes form the locking member insertion cavity, and the locking pin simultaneously passes through the two locking pin holes.

In an embodiment, the plug main body has a top surface away from the connection port, a lid-opening protrusion is provided on the top surface, and the lid-opening protrusion is located on a side of the plug main body away from the connecting member.

In an embodiment, a recess is provided on the top surface, the recess is located on a side of the lid-opening protrusion away from the connecting member, and a projection of the recess onto the top surface along the pull-out direction and a projection of the lid-opening protrusion onto the top surface along the pull-out direction are connected or partially overlap.

In an embodiment, the lid-opening protrusion is arranged obliquely, and a distance between a top of the lid-opening protrusion and the connecting member is greater than a distance between a bottom of the lid-opening protrusion and the connecting member.

Another embodiment of the present disclosure provides an earphone. The earphone includes: an earphone main body, an interface plug, and a locking member. The earphone has a structure defined by the electronic device according to any one of the embodiments mentioned above. The device main body in the electronic device is the earphone main body.

Beneficial effects of the embodiments of the present disclosure are as follows. The locking member can be adapted to the limiting structure on the connecting member to block the interface plug from detaching from the device main body. Meanwhile, the locking member is inserted into the locking member insertion cavity on the device main body, and the insertion direction of the locking member when being inserted into the locking member insertion cavity and a pull-out direction of the interface plug when being pulled out from the connection port form an included angle. When the interface plug is pulled out from the connection port, the included angle can at least prevent a portion of the pull-out force from being transmitted to the locking member along the insertion direction of the locking member, which helps prevent the locking member from detaching from the limiting structure. This is further beneficial for keeping the interface plug locked by the locking member. The connection firmness and reliability between the interface plug and the device main body can be improved, and is beneficial for extending the service life of the interface plug.

### BRIEF DESCRIPTION OF THE DRAWINGS

FIG. 1 is a schematic structural diagram of an earphone according to an embodiment of the present disclosure.

FIG. 2 is a schematic structural diagram of the earphone in FIG. 1 from another perspective.

FIG. 3 is a partial enlarged view of a connection portion of an interface plug of an earphone.

FIG. 4 is an exploded structural diagram of an earphone main body, an interface plug, and a locking member in FIG. 3.

FIG. 5 is an exploded structural diagram of the earphone main body and the interface plug in FIG. 3.

FIG. 6 is a 3D diagram of the interface plug in FIG. 3.

FIG. 7 is a front diagram of the interface plug.

FIG. 8 is a schematic diagram of a cross-section of FIG. 3.

FIG. 9 is a schematic diagram of another cross-section of FIG. 3.

FIG. 10 is a schematic structural diagram of an interface plug in another embodiment of an earphone according to the present disclosure.

FIG. 11 is a schematic diagram of a connection state between the interface plug of FIG. 10 and an earphone main body.

List of reference numerals corresponding to features in the drawings: 100: rear hook; 200: ear hook; 300: electronic control unit; 310: housing; 320: control button; 330: locking member insertion cavity; 340: connection side surface; 341: mounting groove; 342: embedding slot; 350: locking member embedding groove; 360: connection port; 361: exposure opening; 362: charging terminal; 400: sound generating unit; 500: interface plug; 510: plug main body; 511: insertion portion; 512: sealing protrusion; 513: limiting portion; 514: recess; 520: connecting member; 521: columnar body; 522: limiting protrusion; 523: inner protrusion; 530: lid-opening protrusion; 600: locking member; 610: stop component; 620: insertion component; 630: ear component; 710: insertion hole; 720: locking pin; 730: insertion channel.

### DETAILED DESCRIPTION

The present disclosure is further described in detail below with reference to the accompanying drawings and embodiments. It is specifically pointed out that the following embodiments are only used to illustrate the present disclosure, but do not limit the scope of the present disclosure. Similarly, the following embodiments are only some embodiments of the present disclosure rather than all embodiments. All other embodiments obtained by a person of ordinary skill in the art based on the embodiments of the present disclosure, without creative efforts, shall fall within the protection scope of the present disclosure.

In the embodiments of the present disclosure, an interface plug is fixed to a device main body by a locking member. The device main body is provided with a locking member insertion cavity. An insertion direction when the locking member is inserted into the locking member insertion cavity and a pull-out direction when the interface plug is pulled out from the connection port form an included angle. When the interface plug is pulled out from the connection port on the device main body, the included angle can at least avoid a portion of a pull-out force from being transmitted to the locking member along the insertion direction of the locking member. This is conducive to avoiding the locking member from being separated from a limiting structure on the interface plug. The interface plug can be more firmly connected to the device main body.

Embodiments of an earphone in the present disclosure are as follows.

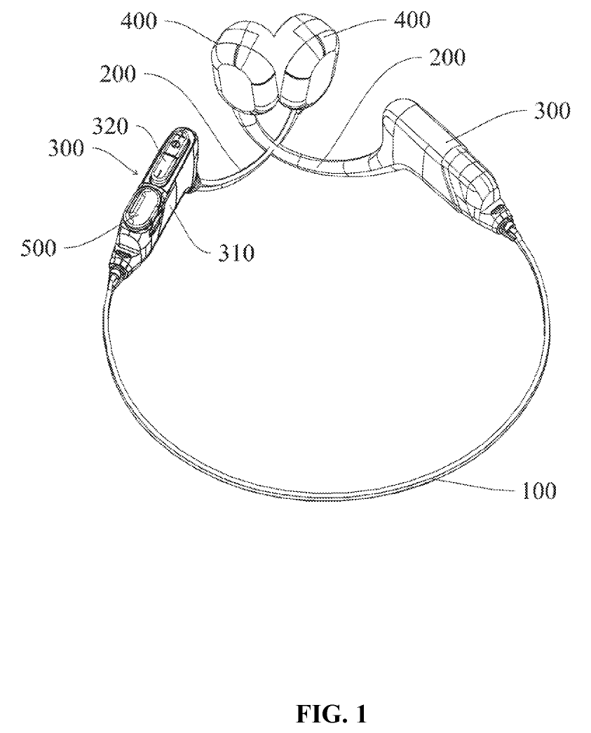

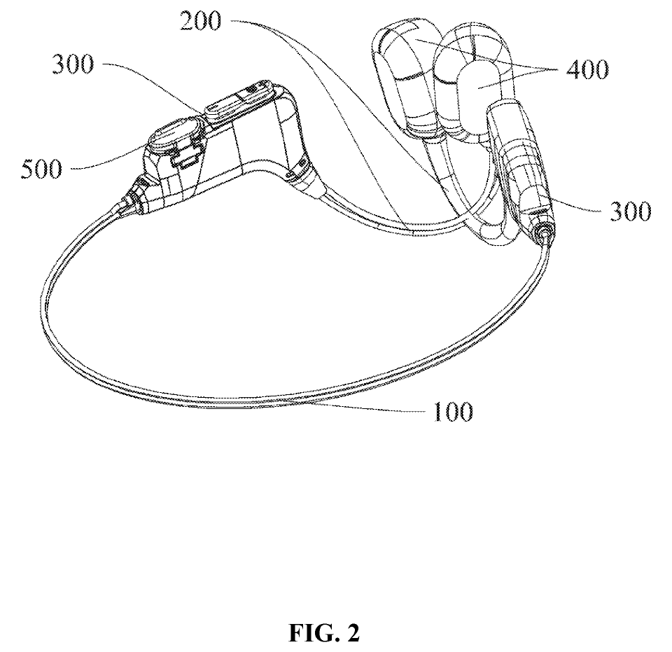

FIG. 1-FIG. 2 are schematic structural diagrams of some embodiments of an earphone in the present disclosure. As shown in FIG. 1-FIG. 2, in an embodiment, the earphone may be a bone conduction earphone, including a rear hook 100, an ear hook 200, an electronic control unit 300, and a sound generating unit 400. The rear hook 100 is connected between two electronic control units 300. The ear hook 200 is connected between the electronic control unit 300 and the sound generating unit 400 located on the same side.

A person skilled in the art should understand that the rear hook 100 may be elastic, so that the rear hook 100 is able to be elastically deformed and automatically rebound. This facilitates forming a certain tightness force between the earphone and a user's head, and the earphone can be more stably worn on the user's body (for example, on a face near an ear). The ear hook 200 may be set to a shape adapted to the user's ear. For example, the ear hook 200 may be an arc-shaped structure, and can be hung above the user's ear.

The electronic control unit 300 may include a housing 310, a circuit board, a control button 320, etc., and is able to implement signal processing and electronic control of the earphone. It should be noted that the electronic control unit 300 may further include a power module. The power module is able to supply power to the earphone. Among the two electronic control units 300 disposed at the two ends of the rear hook 100, only one electronic control unit 300 may include the power module, or each electronic control unit 300 may include the power module.

The sound generating unit 400 is configured to be attached to a corresponding position on the user's head and is able to convert sound into mechanical vibration, thereby implementing sound transmission through the skull, bony labyrinth, endolymph, etc.

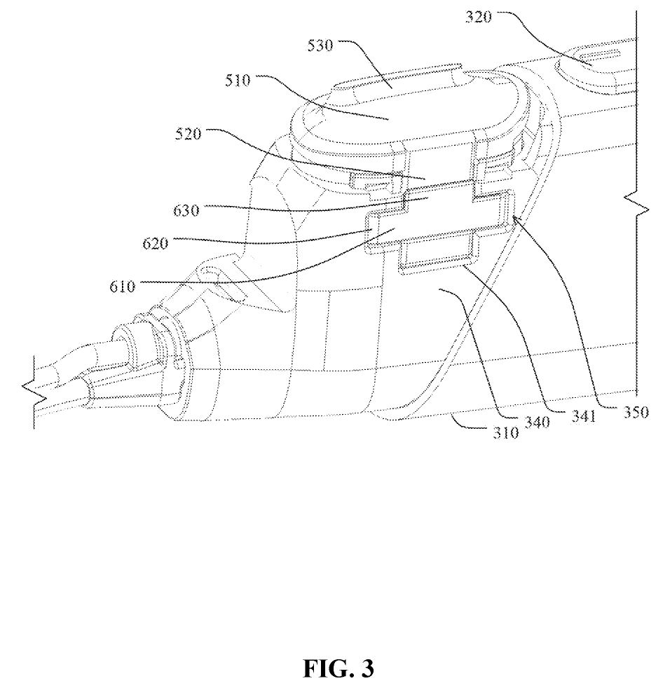

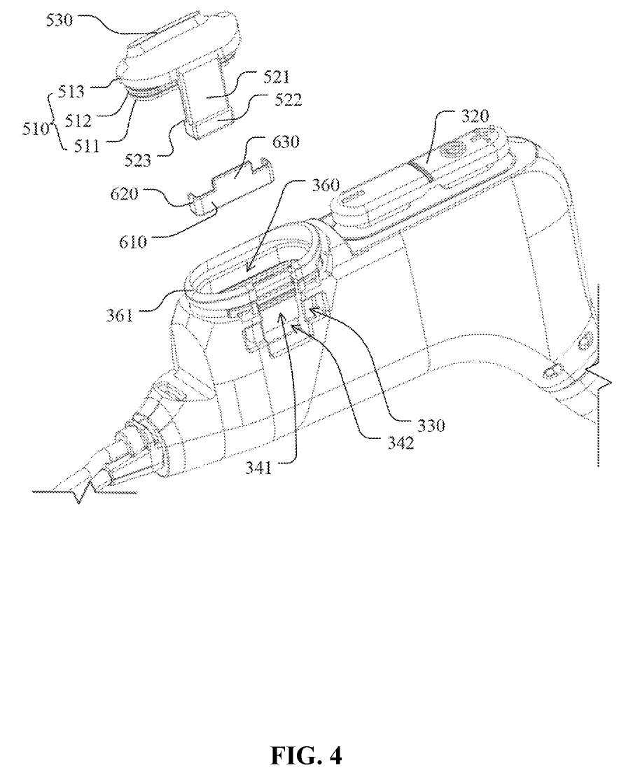

Referring to FIG. 3-FIG. 4, FIG. 3 is a partial enlarged view of a connection portion of an interface plug 500 of an earphone. FIG. 4 is an exploded structural diagram of an earphone main body, the interface plug 500, and a locking member 600 in FIG. 3. It can be understood with reference to the drawings that the electronic control unit 300 is provided with a connection port 360. The connection port 360 may be a charging interface. The charging interface may be configured for a charging cable to be inserted to charge the power module.

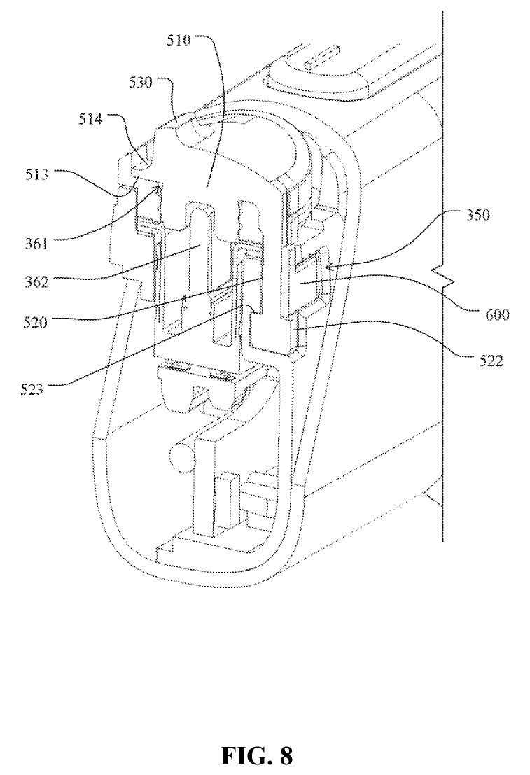

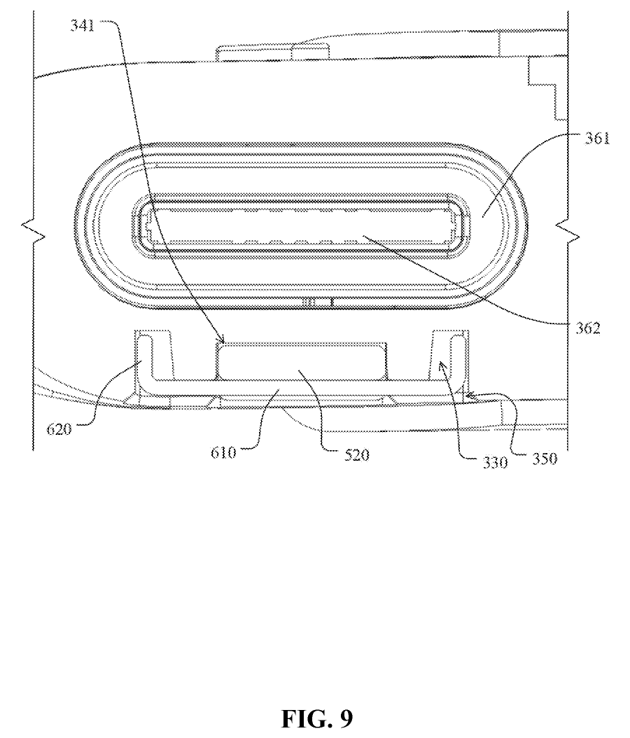

In an embodiment, the connection port 360 forms a recess in the housing 310. The recess may be configured for a head end of a charging cable to be inserted. Referring to FIG. 4 (FIG. 8-FIG. 9 may be referred to at the same time), the connection port 360 includes an exposure opening 361 provided on the housing 310 of the electronic control unit 300, and further includes a charging terminal 362 provided in the exposure opening 361 (a structure of the charging terminal 362 may be referred to in FIGS. 8-9). The exposure opening 361 refers to a through hole provided on the housing 310. The through hole is configured to expose the charging terminal 362 provided in the housing 310. In this way, the charging cable is able to be inserted into the housing 310 from a corresponding portion of the housing 310 to connect to the charging terminal 362. The shape of the exposure opening 361 may match a contour of the charging terminal 362. A person skilled in the art can understand that a structural form of the charging terminal 362 may be selected from a plurality of structural forms. For example, a Micro-USB interface may be selected. The Micro-USB interface has a characteristic that the interface shape is trapezoidal, and a socket is small. A Micro-USB charging cable of a corresponding shape needs to be inserted for charging. As another example, a Type-C interface may be selected. The Type-C interface has characteristics that a socket is large, a shape is oval, the interface supports forward and reverse insertion, a charging speed is fast, and a transmission efficiency is high. The Type-C interface is adopted by more and more devices. The illustrated embodiment uses the Type-C interface. Certainly, an earphone using a Type-C interface needs to insert a Type-C charging cable of a corresponding shape for charging. As another example, a Lightning interface may be selected. The Lightning interface is an interface unique to Apple Inc., and is configured to connect to Apple mobile devices, and a plurality of functions can be implemented through one interface.

The charging interface for a charging cable to be inserted forms an exposed conductive contact. After charging is completed or when the charging interface is not in use, liquid, dust, foreign matter, etc., may enter the charging interface. This may cause damage to the earphone or affect the normal use of the charging interface. In addition, in some cases, it is necessary to consider the waterproof and dustproof levels of the earphone. To resolve this problem, the earphone further includes an interface plug 500. The interface plug 500 includes a plug main body 510 and a connecting member 520. The plug main body 510 is configured to be inserted into the connection port 360. The connecting member 520 is connected between the plug main body 510 and the earphone main body. It should be understood that for the connection port 360, including the exposure opening 361 and the charging terminal 362 mentioned above, when the plug main body 510 is inserted into the connection port 360, the plug main body 510 may actually be inserted into the exposure opening 361. The plug main body 510 may occupy a portion of the space in the exposure opening 361, or may occupy all the space in the exposure opening 361. In some other embodiments, the plug main body 510 may further occupy a portion or all of the space of the charging terminal 362. In addition, according to different structures of the connection port 360, the space occupied by the plug main body 510 after being inserted into the connection port 360 may also be different. The interface plug 500 may be manufactured by using a plurality of materials, e.g., silicone, rubber, thermoplastic polyurethanes (TPU), or thermoplastic elastomer (TPE). The material of the interface plug 500 may have elasticity, which allows the interface plug 500 to deform more tightly with the connection port 360 through its own elastic deformation, thus better exerting its protective effect.

In an embodiment, the shape of the plug main body 510 is adapted to the connection port 360 on the electronic control unit 300. The plug main body 510 is able to be inserted into the connection port 360 and is sealed with the connection port 360. In a specific embodiment, the plug main body 510 may include an insertion portion 511 and a limiting portion 513. The insertion portion 511 is configured to be inserted into the connection port 360. The limiting portion 513 is configured to be supported on an opening edge of the connection port 360 to limit an insertion depth of the plug main body 510. To achieve a good sealing effect, two or more sealing protrusions 512 are provided on an outer peripheral surface of the insertion portion 511. The sealing protrusions 512 are arranged along an insertion and pull-out direction of the interface plug 500, similar to two or more sealing rings. This can not only meet sealing requirements, but also form friction to avoid the plug main body 510 from falling out of the connection port 360 relatively easily.

It should be noted that in some other embodiments, the plug main body 510 may also be replaced by another structure. For example, the plug main body 510 may be a columnar structure completely adapted to the shape of an inner cavity of the connection port 360. In addition, the outer peripheral surface of the plug main body 510 may also be a smooth surface, i.e., the sealing protrusions 512 mentioned above may be omitted.

The connecting member 520 is configured to maintain a connection between the plug main body 510 and the earphone main body, to avoid the interface plug 500 from being separated from the earphone main body and lost. In an embodiment, the connecting member 520 is connected to one side of the plug main body 510, and an extension direction is parallel to the insertion and pull-out direction of the interface plug 500. When the interface plug 500 needs to be pulled out, a user may apply a pull-out force to the plug main body 510. The pull-out force may have an inclination angle relative to the insertion and pull-out direction of the interface plug 500, e.g., biased toward a side of the interface plug 500 provided with the connecting member 520. The plug main body 510 moves along an orientation of the connection port 360 and may generate a certain flip, and finally is separated from the connection port 360. In this process, the connecting member 520 may form a hinge by relying on its own elastic deformation, and may be stretched to produce a certain amount of elastic elongation, facilitating the plug main body 510 to be separated from the connection port 360. It should be noted that the connecting member 520 and the plug main body 510 mentioned above may be integrally formed, or may be manufactured separately and then assembled together.

Referring to FIG. 4, in an embodiment, the connecting member 520 includes a columnar body 521 and a limiting protrusion 522. The limiting protrusion 522 protrudes from a side surface of the columnar body 521. The limiting protrusion 522 forms a limiting structure. The limiting structure can cooperate with a corresponding locking member 600 to block the connecting member 520 from moving along the pull-out direction of the interface plug 500. The pull-out direction of the interface plug 500 is also an orientation of the connection port 360. Since the locking member 600 is provided on a side of the connecting member 520 away from the earphone main body, in order to enable the locking member 600 to form a block on the connecting member 520, the limiting protrusion 522 is provided on a side of the columnar body 521 close to the locking member 600, i.e., provided on a side of the columnar body 521 away from the earphone main body. The limiting protrusion 522 may be a square protrusion. A side of the limiting protrusion 522 close to the plug main body 510 may form a stop surface. The stop surface is able to be blocked by the locking member 600 in the pull-out direction of the interface plug 500, thereby preventing the interface plug 500 from being separated from the earphone main body. A structure of the locking member 600 is described below.

It can be understood with reference to FIG. 3-FIG. 4 shows that the earphone main body is provided with a locking member insertion cavity 330. The locking member 600 is inserted into the locking member insertion cavity 330. An insertion direction when the locking member 600 is inserted into the locking member insertion cavity 330 and the pull-out direction when the interface plug 500 is pulled out from the connection port 360 have an included angle. The locking member 600 blocks the limiting structure along the pull-out direction of the interface plug 500. In some embodiments, a protrusion height of the limiting protrusion 522 for forming the limiting structure may match the locking member 600. An outer side surface of the limiting protrusion 522 may be in the same plane as a corresponding side surface of the locking member 600. In this way, when the limiting protrusion 522 protrudes from the locking member 600, collision with another object can be avoided, and damage or displacement of the connecting member 520 due to collision can be avoided, so that reliability and structural stability are better.

By relying on the included angle between the insertion direction of the locking member 600 and the pull-out direction of the interface plug 500, the included angle can at least avoid a part of the pull-out force from being transmitted to the locking member 600 along the insertion direction of the locking member 600. This is conducive to avoiding the locking member 600 from being separated from the limiting structure, so that the interface plug 500 can be more reliably connected to the earphone main body, and separation of the interface plug 500 caused by pulling out the interface plug 500 is reduced or avoided, thereby avoiding product damage caused thereby.

In an embodiment, the insertion direction is perpendicular to the pull-out direction. In this way, the pull-out force of the plug main body 510 can be better avoided from being transmitted to the locking member 600 along the insertion direction of the locking member 600, and separation of the interface plug 500 can be better avoided. A person skilled in the art can understand that the perpendicular defined in the embodiments of the present disclosure does not limit an included angle between the two directions to be absolutely 90°, and a deviation within 10% is allowed. In some other embodiments, the included angle between the insertion direction and the pull-out direction may also be another angle value.

In a specific embodiment, the earphone main body has a connection side surface 340 for the connecting member 520 to be connected. The connection side surface 340 is provided with a mounting groove 341 extending along the pull-out direction. At least a portion of the connecting member 520 is embedded in the mounting groove 341 along a groove depth direction of the mounting groove 341. Providing the mounting groove 341 is beneficial for reducing the height of the connecting member 520 protruding from the earphone main body, thus the connection between the plug main body 510 and the earphone main body is more stable. The groove side wall of the mounting groove 341 can provide a limiting function for the connecting member 520. This is beneficial for avoiding tilting of the connecting member 520 and the limiting structure on the connecting member 520 toward one side in a groove width direction of the mounting groove 341. This further avoids affecting a cooperation area between the locking member 600 and the limiting structure and affecting a blocking effect of the locking member 600 on the limiting structure. In some embodiments, the connecting member 520 may be completely embedded in the mounting groove 341. A side surface of the connecting member 520, away from the groove bottom wall of the mounting groove 341, is located on the same plane as the opening edge of the mounting groove 341. This is beneficial for avoiding collisions between the connecting member 520 and other objects, which affects structural stability.

In one embodiment, referring to FIG. 4, the locking member 600 includes a stop component 610 and an insertion component 620. The stop component 610 blocks the limiting protrusion 522 from moving toward the columnar body 521. The insertion component 620 is connected to the stop component 610. The insertion component 620 and the stop component 610 have an included angle. The locking member insertion cavity 330 is an insertion recess provided on the connection side surface 340. The insertion component 620 is inserted into the insertion recess. It can be understood that "stop" means blocking or stopping. The stop component 610 refers to a portion capable of blocking or stopping the movement of a corresponding component and capable of exerting a limiting function. Providing the stop component 610 is beneficial for increasing the cooperation area between the limiting structure on the connecting member 520 and the locking member 600, thereby improving the blocking effect.

The insertion component 620 of the locking member 600 may be perpendicular to the stop component 610. This facilitates installation and potential disassembly of the locking member 600. When installing the locking member 600, the locking member 600 is moved toward the locking member insertion cavity 330 on the earphone main body along a direction perpendicular to the stop component 610. The locking member 600 can then be assembled onto the earphone main body. It can be understood that, when assembling the locking member 600, to better avoid the locking member 600 detaching from the earphone main body, an interference fit may be adopted between the locking member 600 and the earphone main body, or an anti-detachment structure may be provided. For example, the insertion component 620 of the locking member 600 may form an interference fit with a cavity side wall of the locking member insertion cavity 330. The portions forming the interference fit may be portions on two sides of the insertion component 620 along the insertion and pull-out direction of the interface plug 500, or may be portions on two sides of the insertion component 620 along a width direction of the insertion recess. As another example, an adhesive structure, a snap-fit structure, a screw structure, etc., may be provided between the locking member 600 and the earphone main body as the anti-detachment structure. As yet another example, the insertion component 620 of the locking member 600 may be inserted into the locking member insertion cavity 330. After the connecting member 520 is pressed and fixed onto the earphone main body, an elastic covering layer is applied over the entire outer side of the earphone. The elastic covering layer covers the locking member 600, the connecting member 520, etc., which is more aesthetically pleasing. The elastic covering layer also prevents the insertion component 620 of the locking member 600 from detaching from the locking member insertion cavity 330, thereby avoiding a situation where the insertion component 620 detaches from the locking member insertion cavity 330 and affects the reliability of the electronic device. Certainly, in some other embodiments, the elastic covering layer may be provided only on the electronic control unit 300, which can likewise prevent the locking member 600 from detaching.

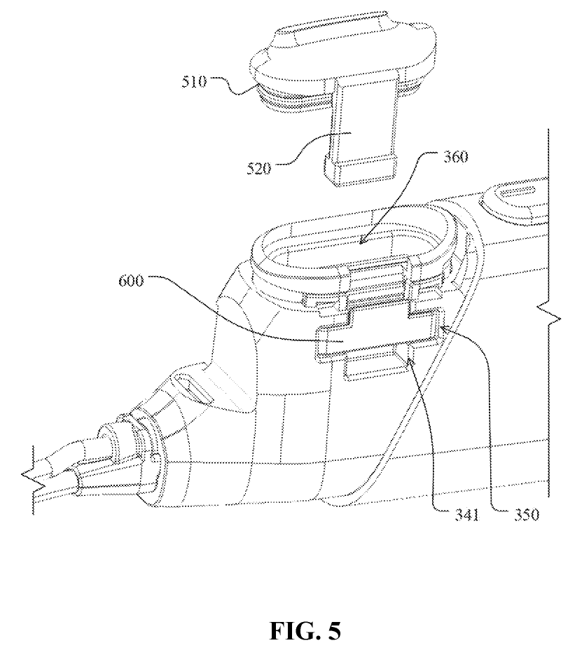

Referring to FIG. 3-FIG. 4, and additionally referring to FIG. 5, FIG. 5 is an exploded structural diagram of the earphone main body and the interface plug 500 in FIG. 3. In a specific embodiment, two insertion components 620 are provided. The two insertion portions 511 are respectively provided at opposite ends of the stop component 610. The corresponding two insertion recesses are respectively located on two sides of the mounting groove 341 in the groove width direction of the mounting groove 341. Providing two insertion components 620 enables both ends of the stop component 610 to be connected with the earphone main body. The stress stability of the stop component 610 is better. The connection with the earphone main body is more reliable.

With reference to FIG. 3-FIG. 5, it can be understood that, in some embodiments, the locking member 600 may be sheet-shaped. It should be noted that the locking member 600, being sheet-shaped, does not limit the locking member 600 to a planar structure, but means that both the stop component 610 and the insertion component 620 of the locking member 600 are sheet bodies.

In other embodiments, the locking member 600 may have only one insertion component 620. For example, only one insertion component 620 is provided on one side in the width direction of the insertion recess. As another example, one insertion component 620 may be provided on the earphone main body on a side of the connecting member 520 away from the plug main body 510.

In one embodiment, the locking member 600 includes an ear component 630. The ear component 630 is connected to a side of the stop component 610 away from the limiting protrusion 522. The ear component 630 covers at least a portion of the columnar body 521. Providing the ear component 630 on the locking member 600 enables the locking member 600 and the side wall of the mounting groove 341 to form a larger cooperation area. This is more beneficial for the stable assembly of the locking member 600. In one specific embodiment, the ear component 630 may also be omitted.

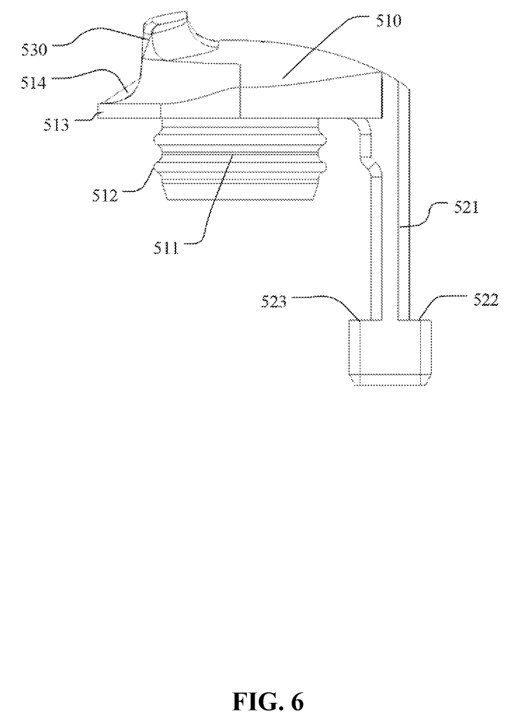

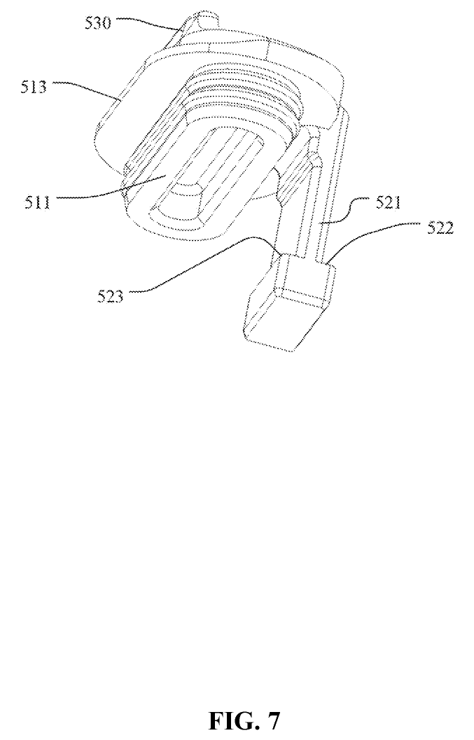

FIG. 6 is a 3D diagram of the interface plug 500 in FIG. 3. FIG. 7 is a front diagram of the interface plug 500. With reference to FIG. 6-FIG. 7, it can be understood that the columnar body 521 may have an inner side surface facing the groove bottom wall of the mounting groove 341. An inner protrusion 523 is provided on the inner side surface. An embedding slot 342 is provided on the groove bottom wall of the mounting groove 341. The inner protrusion 523 is embedded in the embedding slot 342. Through the cooperation between the embedding slot 342 and the inner protrusion 523, the embedding slot 342 can provide a blocking function for the inner protrusion 523 on the connecting member 520, which can also block the protruding portion on the connecting member 521 from moving toward the columnar body 521. Thus, detachment of the connecting member 520 from the earphone main body can be more reliably avoided. It should be noted that the inner protrusion 523 provided on a side of the connecting member 520 close to the earphone main body may be a square protrusion as shown in the drawings, or may have other shapes. Merely by way of example, the other shapes include a semicircular shape, a trapezoidal shape, a triangular shape, a semi-elliptical shape, etc. These shapes refer to a cross-sectional shape of the inner protrusion 523, with the cross-sections perpendicular to the insertion and pull-out direction of the interface plug 500. Furthermore, in a specific embodiment, the limiting protrusion 522 provided on a side away from the earphone main body may have other shapes, such as, a semicircular shape, a trapezoidal shape, a triangular shape, a semi-elliptical shape, etc.

The connection structure between the interface plug 500 and the earphone main body may be further understood with reference to FIG. 8-FIG. 9. FIG. 8 is a schematic diagram of a cross-section of FIG. 3. The section plane is parallel to the insertion and pull-out direction of the interface plug 500 and passes through a symmetry center of the interface plug 500. FIG. 9 is a schematic diagram of another cross-section of FIG. 3. The section plane is perpendicular to the insertion and pull-out direction of the interface plug 500 and passes through the locking member 600. As shown in FIG. 8, besides the locking member insertion cavity 330, the earphone main body is also provided with a locking member embedding groove 350, i.e., a recess for embedding the locking member 600 to achieve installation. The locking member 600 is embedded in the locking member embedding groove 350. Providing the locking member embedding groove 350 can prevent the locking member 600 from protruding from the earphone main body, which can also limit the locking member 600. This is beneficial for reliably keeping the locking member 600 on the earphone main body.

In one embodiment, the plug main body 510 has a top surface away from the connection port 360. A lid-opening protrusion 530 is provided on the top surface. The lid-opening protrusion 530 is located on a side of the plug main body 510 away from the connecting member 520. By providing the lid-opening protrusion 530, when a user needs to open the interface plug 500, the user can apply a force inclined toward the connecting member 520 to the lid-opening protrusion 530 with a finger, making it easier for the user to operate.

In a specific embodiment, a recess 514 may be provided on the top surface of the plug main body 510. The recess 514 is located on a side of the lid-opening protrusion 530 away from the connecting member 520. A projection of the recess 514 and a projection of the lid-opening protrusion 530 on the top surface along the pull-out direction are connected or partially overlap. A person skilled in the art can understand that the recess 514 allows a user's finger to extend into it, thereby forming a larger action area with the lid-opening protrusion 530. The recess 514 is also beneficial for causing a force for pulling out the interface plug 500 to incline toward a side of the interface plug 500 where the connecting member 520 is provided, making it easier to open the interface plug 500.

A person skilled in the art can understand that, since the interface plug 500 is inserted into the connection port 360, a larger force along the pull-out direction of the interface plug 500 is more beneficial for smooth pulling out of the interface plug 500. Therefore, the lid-opening protrusion 530 may be arranged obliquely. A distance between a top of the lid-opening protrusion 530 and the connecting member is greater than a distance between a bottom of the lid-opening protrusion 530 and the connecting member, allowing a user's finger to more easily apply a force along the pull-out direction of the interface plug 500 to the interface plug 500.

The insertion and pull-out operation of the interface plug 500 of the earphone is described below.

When charging the earphone, the interface plug 500 first needs to be opened. During operation, the user may place a finger on a side of the lid-opening protrusion 530 away from the connecting member 520. Then, a force is applied to the lid-opening protrusion 530. A direction of the force may be toward the connecting member 520, and a component force toward the pull-out direction of the interface plug 500 is formed as much as possible. Under the user's operation, the plug main body 510 of the interface plug 500 is able to generate a tendency to tilt and flip toward a side of the interface plug 500 where the connecting member 520 is provided, and may also generate a certain bending deformation. The connecting member 520 may generate a certain tensile deformation. As the force and displacement increase, the plug main body 510 eventually detaches from the connection port 360, thereby exposing the connection port 360 for insertion of a charging connector. Due to the limitation of the connecting member 520, the interface plug 500 does not completely detach from the earphone main body, which helps prevent the interface plug 500 from being lost. In the above process, the direction of the blocking force applied by the locking member 600 to the connecting member 520 is perpendicular to the pull-out direction of the interface plug 500. Therefore, the interface plug 500 is not prone to detaching from the earphone main body, which helps ensure the reliable fixation of the interface plug 500. When inserting the interface plug 500, one end of the interface plug 500 is aligned with the connection port 360, and then a pressing force is applied.

In some related technologies, the connecting member 520 of the interface plug 500 is adhesively fixed onto the earphone main body using glue after being assembled to a set position on the earphone main body. However, this adhesive manner heavily relies on factors such as reliability, heat resistance, aging degree, etc., of the glue, which is prone to failure during use. In contrast, embodiments of the present disclosure change the direction of force action. The interface plug 500 is fixed by the locking member 600. This enables at least a portion of the force when opening the interface plug 500 to avoid the pull-out direction of the locking member 600. As long as the locking member 600 is firmly fixed, the interface plug 500 is difficult to detach. Thus, more reliable fixation of the interface plug 500 is achieved relying on a mechanical structure.

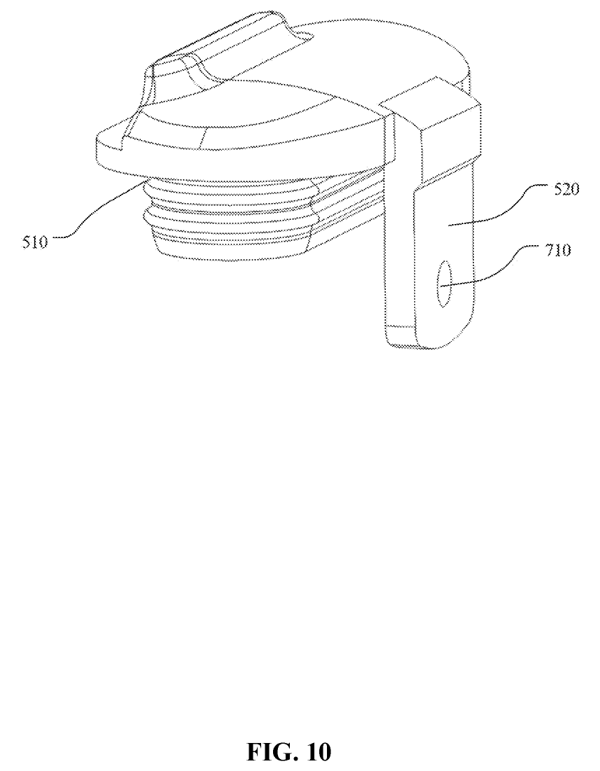

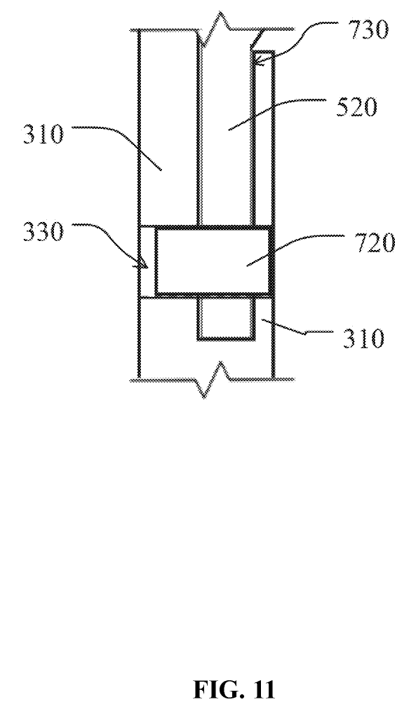

FIG. 10 is a schematic structural diagram of an interface plug 500 in another embodiment of an earphone according to the present disclosure. With reference to FIG. 10, it can be understood that the cooperation between the locking member 600 and the limiting structure on the connecting member 520 may also be replaced with other forms. Referring to FIG. 10-FIG. 11, in one embodiment, an insertion hole 710 is provided on the connecting member 520. The limiting structure is formed by the insertion hole 710. The locking member 600 is a locking pin 720. The locking pin 720 is simultaneously inserted into the locking member insertion cavity 330 and the insertion hole 710. The locking member insertion cavity may be a locking pin hole provided on the earphone main body. The locking pin 720 mentioned above also has an included angle with the pull-out direction of the interface plug 500. For example, the locking pin 720 may be arranged perpendicularly. In this way, when the connecting member 520 is subjected to a force along the pull-out direction, the locking pin 720 only needs to withstand a tensile force along the pull-out direction, and the tensile force does not cause the locking pin 720 to detach from the locking member insertion cavity 330. Therefore, the connection reliability of the interface plug 500 can be improved.

In a specific embodiment, an insertion channel 730 may be provided on the earphone main body. An axis of the insertion channel 730 is parallel to the pull-out direction. The connecting member 520 is inserted into the insertion channel 730. A locking pin hole is provided on a side wall of the insertion channel 730. The locking pin hole forms the locking member insertion cavity 330. The insertion channel 730 can restrict displacement of the connecting member 520 along an axial direction of the locking pin 720, thereby more effectively preventing the locking pin 720 from detaching. Consequently, the connection reliability of the interface plug 500 can be more effectively ensured. A person skilled in the art should understand that one locking pin hole may be provided on each of two opposite side walls of the insertion channel 730. Two ends of the locking pin 720 may be respectively inserted into the two locking pin holes. A middle portion of the locking pin 720 is configured to fix the connecting member 520 of the interface plug 500.

An embodiment of the electronic device in the present disclosure is as follows.

The electronic device includes a device main body, an interface plug 500, and a locking member 600. The connection port 360 is provided on the device main body. The interface plug 500 includes a plug main body 510 and the connecting member 520. The plug main body 510 is configured to be inserted into the connection port 360. The connecting member 520 is connected between the plug main body 510 and the device main body. The locking member insertion cavity 330 is provided on the device main body. The locking member 600 is inserted into the locking member insertion cavity 330. An insertion direction of the locking member 600 when being inserted into the locking member insertion cavity 330 and a pull-out direction of the interface plug 500 when being pulled out from the connection port form an included angle. A limiting structure is provided on the connecting member 520. The locking member 600 blocks the limiting structure along the pull-out direction. Relying on the included angle between the insertion direction when the locking member 600 is inserted into the locking member insertion cavity 330 and the pull-out direction of the interface plug 500, at least a portion of a force along the pull-out direction applied to the interface plug 500 does not act on the insertion direction of the locking member 600, avoiding failure of the locking member 600, and thereby avoiding the interface plug 500 being pulled out.

It should be understood that the device main body may be an earphone main body in an embodiment of an earphone of the present disclosure, or may be a main body of another device, such as a main body of a bone conduction earphone, or a main body of a device other than an earphone. For an earphone, the earphone may also be an earphone having only the ear hook 200 without the rear hook 100.

Finally, it is to be noted that the reference to "an embodiment" in the present disclosure means that a particular feature, structure, or characteristic described in connection with the embodiment may be included in at least one embodiment of the present disclosure. Those skilled in the art should understand that the various embodiments described in the present disclosure may be combined with other embodiments. In addition, in the embodiments of the present disclosure, many details are described for a better understanding of the present disclosure. However, those skilled in the art can readily recognize that some of the features may be omitted under different circumstances, or may be replaced by other features. In some cases, some operations related to the present disclosure are not shown or described in the specification. This is to avoid the core part of the present disclosure from being overwhelmed by excessive description. For those skilled in the art, detailed description of these related operations is not necessary, and they can fully understand the related operations based on the description in the specification and general technical knowledge in the art. The terms "connection" and "coupling" as used in the present disclosure, unless otherwise specified, include both direct and indirect connection (coupling).

What is claimed is:

1. An electronic device, comprising:
a device main body provided with a connection port;
an interface plug including a plug main body and a connecting member, wherein the plug main body is configured to be inserted into the connection port, and the connecting member is connected between the plug main body and the device main body; and
a locking member, wherein a locking member insertion cavity is provided on the device main body, the locking member is inserted into the locking member insertion cavity, an insertion direction of the locking member when being inserted into the locking member insertion cavity and a pull-out direction of the interface plug when being pulled out from the connection port form an included angle, a limiting structure is provided on the connecting member, and the locking member blocks the limiting structure along the pull-out direction.

2. The electronic device according to claim 1, wherein the insertion direction is perpendicular to the pull-out direction.

3. The electronic device according to claim 1, wherein
the device main body has a connection side surface for the connecting member to connect thereto,
a mounting groove extending along the pull-out direction is provided on the connection side surface, and
at least a portion of the connecting member along a groove depth direction of the mounting groove is embedded in the mounting groove.

4. The electronic device according to claim 3, wherein
the connecting member includes a columnar body and a limiting protrusion, the limiting protrusion protrudes from a side surface of the columnar body, and the limiting structure is formed by the limiting protrusion;
the locking member includes a stop component and an insertion component, the stop component blocks the limiting protrusion from moving toward the columnar body, the insertion component is connected to the stop component, and the insertion component and the stop component form an included angle; and
the locking member insertion cavity is an insertion recess provided on the connection side surface, and the insertion component is inserted into the insertion recess.

5. The electronic device according to claim 4, wherein
there are two insertion components, the two insertion components are respectively provided at opposite ends of the stop component,
there are two insertion recesses corresponding to the two insertion components, and the two insertion recesses are respectively located on two sides of the mounting groove in a groove width direction.

6. The electronic device according to claim 4, wherein the locking member is sheet-shaped.

7. The electronic device according to claim 6, wherein the locking member includes an ear component, the ear component is connected to a side of the stop component away from the limiting protrusion, and the ear component covers at least a portion of the columnar body.

8. The electronic device according to claim 4, wherein the columnar body has an inner side surface facing a groove bottom wall of the mounting groove, an inner protrusion is provided on the inner side surface, an embedding slot is provided on the groove bottom wall of the mounting groove, and the inner protrusion is embedded in the embedding slot.

9. The electronic device according to claim 3, wherein the connecting member is completely embedded in the mounting groove, and a side surface of the connecting member away from a groove bottom wall of the mounting groove is flush with an opening edge of the mounting groove.

10. The electronic device according to claim 1, wherein an insertion hole is provided on the connecting member, the limiting structure is formed by the insertion hole, the locking member is a locking pin, and the locking pin is simultaneously inserted into the locking member insertion cavity and the insertion hole.

11. The electronic device according to claim 10, wherein an insertion channel is provided on the device main body, an axis of the insertion channel is parallel to the pull-out direction, the connecting member is inserted into the insertion channel, two locking pin holes are provided on two opposite side walls of the insertion channel, the two locking pin holes form the locking member insertion cavity, and the locking pin simultaneously passes through the two locking pin holes.

12. The electronic device according to claim 1, wherein the plug main body has a top surface away from the connection port, a lid-opening protrusion is provided on the top surface, and the lid-opening protrusion is located on a side of the plug main body away from the connecting member.

13. The electronic device according to claim 12, wherein a recess is provided on the top surface, the recess is located on a side of the lid-opening protrusion away from the connecting member, and a projection of the recess onto the top surface along the pull-out direction and a projection of the lid-opening protrusion onto the top surface along the pull-out direction are connected or partially overlap.

14. The electronic device according to claim 12, wherein the lid-opening protrusion is arranged obliquely, and a distance between a top of the lid-opening protrusion and the connecting member is greater than a distance between a bottom of the lid-opening protrusion and the connecting member.

15. The electronic device according to claim 1, wherein the device main body is also provided with a locking member embedding groove configured for embedding the locking member to achieve installation.

16. The electronic device according to claim 1, wherein the plug main body includes an insertion portion and a limiting portion, wherein
the insertion portion is configured to be inserted into the connection port; and
the limiting portion is configured to be supported on an opening edge of the connection port to limit an insertion depth of the plug main body.

17. The electronic device according to claim 16, wherein two or more sealing protrusions are provided on an outer peripheral surface of the insertion portion, and the two or more sealing protrusions are arranged along the pull-out direction of the interface plug.

18. The electronic device according to claim 1, wherein a material of the interface plug has elasticity.

19. An earphone, comprising:
an earphone main body provided with a connection port;
an interface plug including a plug main body and a connecting member, wherein the plug main body is configured to be inserted into the connection port, and the connecting member is connected between the plug main body and the earphone main body; and
a locking member, wherein a locking member insertion cavity is provided on the earphone main body, the locking member is inserted into the locking member insertion cavity, an insertion direction of the locking member when being inserted into the locking member insertion cavity and a pull-out direction of the interface plug when being pulled out from the connection port form an included angle, a limiting structure is provided on the connecting member, and the locking member blocks the limiting structure along the pull-out direction.

20. The earphone according to claim 19, wherein the insertion direction is perpendicular to the pull-out direction.
